(19) United States
(12) Patent Application Publication
(10) Pub. No.: US 2010/0013233 A1
(43) Pub. Date: Jan. 21, 2010

(54) Vertical shaft, horizontally driven, shrouded wind/electric system

(76) Inventor: Barton Albert Buhtz, Sunland, CA (US)

Correspondence Address: Barton A. Buhtz, 8050 Le Berthon Street, Sunland, CA, 91040, US

(21) Appl. No.: 12/218,774

(22) Filed: Jul. 18, 2008

(51) Int. Cl. F03D 9/00; H02K 3/04

(52) U.S. Cl. 290/55; 310/179

(57) ABSTRACT

(1) A vertical shaft, horizontally driven, shrouded wind turbine utilizing one common vertical shaft turned by a series of fixed vertical wing type blades extracting maximum energy from the wind in lift, drag and volume; and (2) an alternator for generating electrical current, with multiple flywheels composed of a nonmagnetic chemical element possessing a free electron and a ring of electrically non-conductive permanent magnets arranged adjacent to each other in magnetic attraction and placed between each disk and ring adjacent to stationary three phase sinusoidal “S” windings of coated copper magnet wire aligned in close proximity to the magnets in each flywheel. Certain elements in the composition of the magnets and metallic chemical element possessing a free electron in motion interact with the copper magnet wires to enhance the flow of paired electrons, thus giving this voltage-intensive alternator the ability to demonstrate remarkably high efficiencies even at relatively low RPMs. The metals in the electromagnetic field are non-ferrous and contain free electrons so any eddy-currents with resultant heat losses are almost nonexistent. If more power output is desired, additional sections can be added to the wind turbine thus capturing more energy from the wind, additional flywheels and copper windings added to the alternator increasing the output generated by this unique wind turbine and electrical generating device. Multiple flywheels and windings, in turn, further reduce the internal resistance against the flow of paired electrons. A wind/electric system with tomorrow's technology for today's world

### BACKGROUND OF THE INVENTION

Around 3000 BC man was capturing energy from the wind to pump water for irrigation and to grind grain. Both the Chinese and the Persians built vertical shaft wind systems to provide the energy needed to perform these tasks. The Persians even built a simple shroud to prevent the wind from hitting the back side of their vertical blades so as to extract the maximum energy from the wind. This inventor simply applied geometric and aerodynamic principles to the design of the vertical shaft and 360 degree shroud immeasurably increasing its efficiency and ability to extract energy in volume rather than simply in a cross section of the wind.

For thousands of years man has sought ways to improve the efficiency of the work he performs. A dramatic change took place during the industrial revolution. Electricity generated by both AC and DC generators, driven by every conceivable means from water to wind, to petroleum based fuels provided relatively cheap energy to produce textiles, steel, machinery for farming, manufacturing and construction among many other uses.

Power lines were stretched across the landscape providing low cost power to homes, farms and businesses, followed quickly by new inventions for improving work efficiency for the farmer, business owners and household residents.

However, in the 1990s society became alarmingly aware of the cost that rapid expansion has brought because little regard was given to the damage such rapid expansion might cause to the environment. Air quality studies in many large metropolitan areas in this century show that the atmosphere is so polluted we are slowly killing ourselves with the side effects of such an energized, mechanized society.

There were those who, from the outset of this explosion of technology, sought to improve its efficiency and reduce its pollution, but they were in the miniscule minority. That, however, is changing as we move into and through the 21st century.

Major manufacturers of electric generators and motors recently intensified their efforts to improve the efficiency of their equipment. Today there are motors and generators on the market with labels showing efficiencies in the high 80% and some even make claims in the low 90%. However, these seeming “high efficiencies” are clouded by the inherent power factor present in every devise, which reduces their true efficiency.

Since the late 1800s permanent magnets have played an ever increasing role in industry. The German, Bloch, discovered the “wall” between the North and South poles of magnets. For years the Alnico magnet was the standard of the industry. It found ready uses in many industrial applications. Then in the early 1960s a new class of magnets was introduced. These new magnets were made of a ceramic “mud” mixed with ferrite particles. This new class of magnets was first utilized in the audio electronic field improving the efficiencies and the quality of audio speakers. There are several characteristics, which set these magnets apart from other permanent magnets. They are lighter in weight, have relatively stronger surface gauss and the ceramic magnet is not electrically conductive.

In the early 1970s further improvements were made in the composition of the ceramic magnet. The percentage of ferrite particles to ceramic “mud” was increased, and the ferrite particles were oriented by subjecting the ceramic and ferrite particles to a strong magnet field as they were formed.

Beginning in the late 1970s and early 1980s these magnets were molded and cut into what became known as “domino magnets” and among other applications were used as magnetos in smaller gasoline engines. A whole market of flexible ceramic magnets became common on refrigerators, vehicle dashboards and on other metallic surfaces to hold notes, memos, etc. and even signs on automobiles and trucks. However, others were testing the use of these ceramic magnets in permanent magnet motor and generator applications.

Most of the research and subsequent developments simply followed the design of the standard motor or generator with a rotor which turned inside a stationary field. Thus the industry concluded that a magnet with a stronger surface gauss was needed and companies have invested millions of dollars developing whole new technologies in the field of permanent magnets such as Rare Earth Cobalt, Strontium among others. These new technology “strong” permanent magnets reveal a dramatic increase in surface gauss.

For the most part the industry has adhered to the belief that iron must be used in permanent magnet configurations to direct or concentrate the magnetic field in the generation of electricity. However, we have discovered a characteristic in the Ceramic magnet, most noticeably the Barium Ferrite Ceramic VIII, when placed in an influenced electromagnetic field, without iron, displays remarkable characteristics which influence and enhance the configuration and potential production of the magnetic field. We have discovered that this magnetic field can be influenced and enhanced in a novel pancake type permanent magnet alternator device. The device has demonstrated remarkably high efficiencies in electrical generation especially at relatively low RPMs.

Experts in electrical generation have known for years that when an electrical current is generated, the losses through eddy currents and heat are reduced when the voltage is relatively high and the amperage relatively low. Thus the internal resistance is reduced and the ready movement of paired electrons is increased.

By placing Ceramic VIII permanent magnets in “pancake” flywheels made of one of the metallic chemical elements which possess a free electron such as Titanium Aluminum, etc., a voltage-intensive alternator has been developed that produces a current with virtually no heat and a high degree of efficiency at relatively low RPMs. Such a novel device will have many ready applications in today's high technology world.

### SUMMARY OF THE INVENTION

In accordance with the invention claimed, a new and improved system of extracting energy from the wind in volume with only one moving part, utilizing the kinetic energy of the wind over a wide range of wind speeds beginning as low as 2 mph and with a self limiting shroud design that eliminates the need to “feather” the blades or shut down the system in high velocity winds. The vertical shaft of the impeller can be direct shaft connected to a gear increasing device mounted on the new and improved generating device as disclosed which employs a novel, multi-pancake type flywheel and copper magnet wire alternator with no iron which can be driven by many and varied suitable means which is capable of producing more electrical generation in combination than would be produced by single flywheel units separately driven.

It is, therefore, one objective of this invention to provide a new and improved method of generating electricity.

Another objective of this invention is to make available a simplified method of providing various outputs of energy generation utilizing a unique expandable component design.

A further objective of this invention is to utilize an improved permanent magnet alternator and/or motor design based on expandable components, simple in construction, low in cost and capable of operating at a wide range of varying and relatively low RPMs.

Still another objective of this invention is to provide improved core segments for electrical generation in an influenced, enhanced, magnetic environment utilizing a simple method of expandable component assembly.

A further objective of this invention is to utilize the increase of enhancement and influence of Ceramic VIII magnets in motion between and adjacent to copper magnet wire sinusoidal configurations which is demonstrated when the Ceramic VIII magnets are placed in a “sandwich” configuration within the flywheel with a thin insulator between the attracting poles of the adjacent magnets within the same flywheel.

Another objective of this invention is to provide a new and improved method and means for generating electricity with set and/or varying RPMs employing a unique magnetic field structure producing extremely high induced voltages from interaction between relatively slow moving permanent magnetic fields employed in a novel enhanced and influenced electromagnetic field structure obtained by aligning each of the three phases in each set of windings between each sets of flywheels then connecting the windings in series. The final three phases of the copper magnet windings are then connected in a “Y” three phase arrangement.

Further objectives and advantages of this invention will become more apparent as the following description proceeds and the features of the novelty which characterizes this invention are pointed out with particularity in the claims annexed to and forming parts of this specification.

### BRIEF DESCRIPTION OF THE DRAWINGS

The present invention may be more readily described by reference to the accompanying drawings, in which,

FIG. A is a perspective view of the vertical shaft, horizontally driven, shrouded wind turbine shroud and impeller.

FIG. B(1) is a top/bottom view of the base, impeller and shroud frame of the wind turbine.

FIG. B(2) is a top/bottom view of the vertical shaft, horizontally drive wind turbine impeller.

FIG. B(3) is a top/bottom view of the base frame with location of the bearing, shaft and alternator in line with the impeller shaft.

FIG. C is a perspective view of the wind turbine impeller

FIG. C(1) is a cross-sectional view of the unique lift/drag system incorporated into the impeller.

FIG. D is a cross-sectional view of the shroud blade

FIG. E is a perspective view of the position of the gear increaser and alternator.

FIG. 1 is a perspective view of the alternator showing the position of the permanent magnet flywheels and the copper magnet wire fields in their physical relation to each other.

FIG. 2 is a perspective view of one of the pancake flywheels employed in the alternator in FIG. 1 with a view of a typical flywheel showing the positioning and relationship of the Ceramic VIII magnets.

FIG. 3 is a perspective view of the position and magnetic field relationship of the Ceramic VIII magnetic field in each pancake flywheel.

FIG. 4 is a perspective view of the three-phase magnet wire holder for positioning the copper magnet wire in the permanent magnet field between, that is, on each side of each flywheel. This is a sectional view of the position of each of the three phases of the copper windings in the three phase magnet wire holder (phases “A, B and C”).

FIG. 5 is a perspective view of how the sinusoidal copper magnet wire is positioned in the winding ring for each of the three electrical generating phases.

### DESCRIPTION OF THE PREFERRED EMBODIMENT

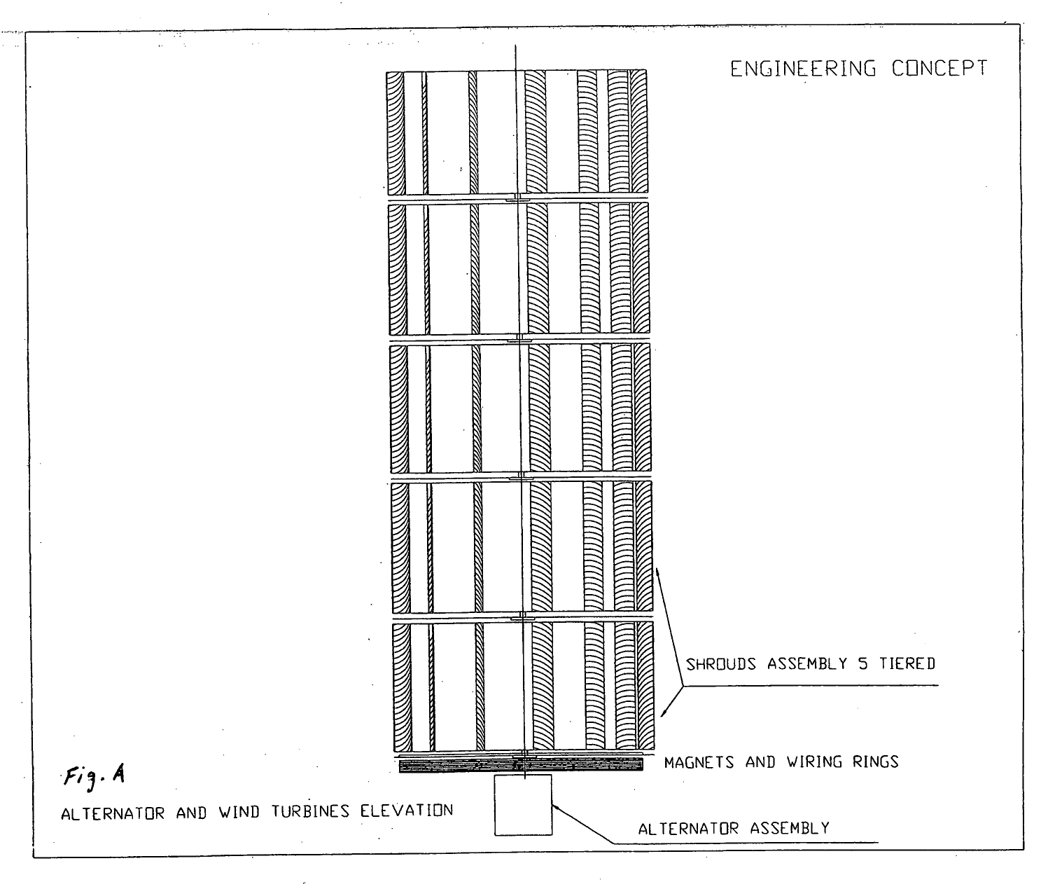

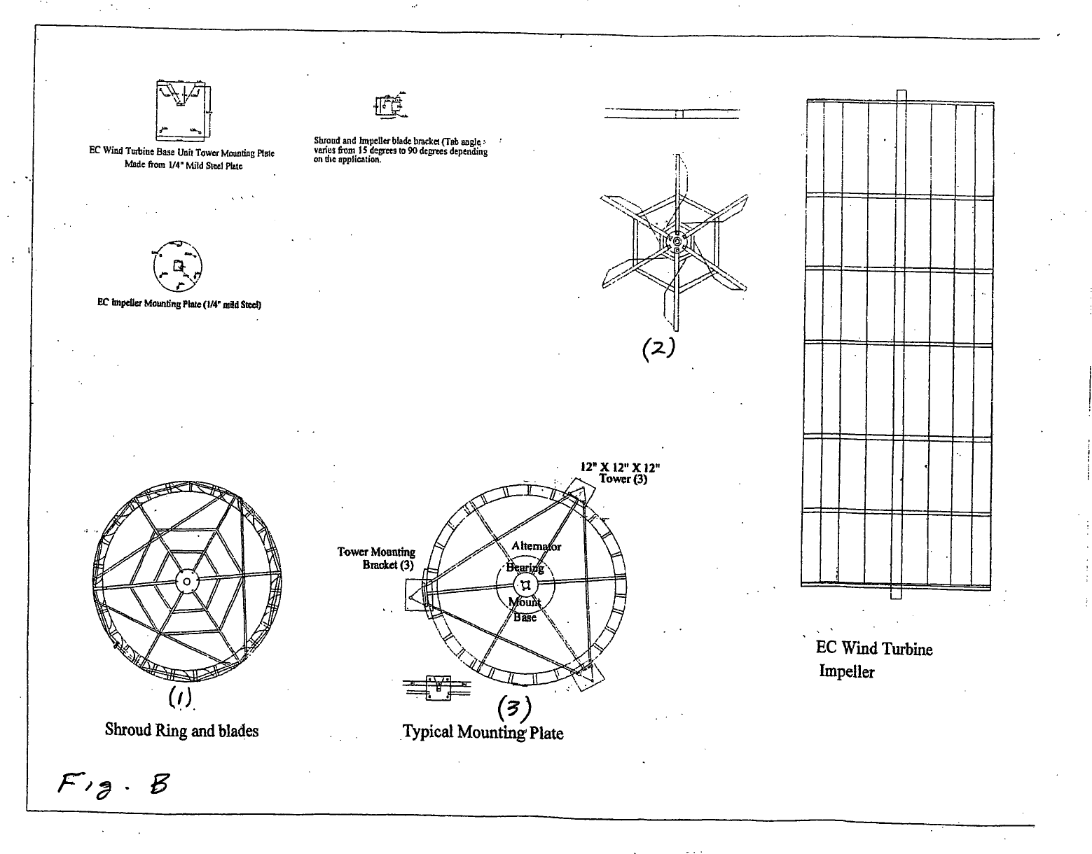

Referring particularly to the drawings by character or number of reference, FIGS. A and B(1-3) disclose the essentials of the wind turbine. FIGS. E and 1-5 disclose an apparatus or device for producing electricity. FIG. E reveals the device in perspective. FIG. 1 identifies the components comprised of multiple flywheels or rotors with magnet wire holders positioned outside and between the flywheels or rotors.

These flywheel/rotors and magnet wire holders are positioned between two housings (Top and Bottom Plates which contain the bearings and bearing housings which, in turn, are coupled to a center shaft which is attached to the pancake flywheels/rotors.

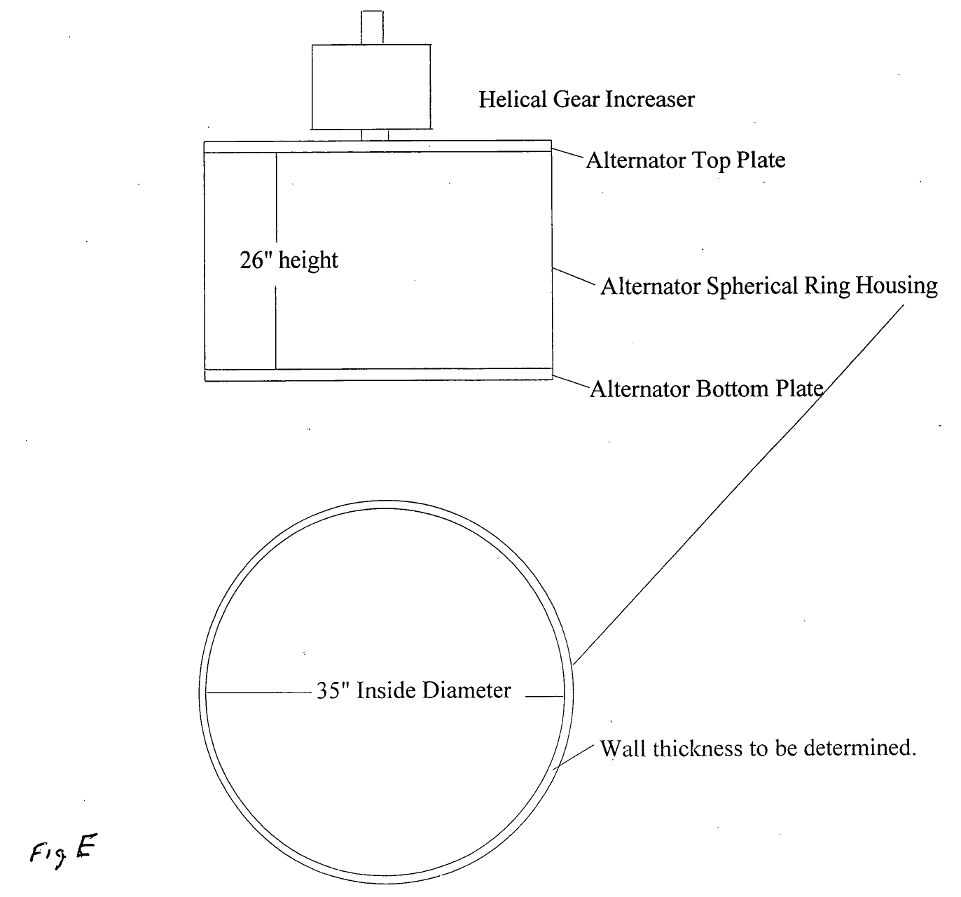

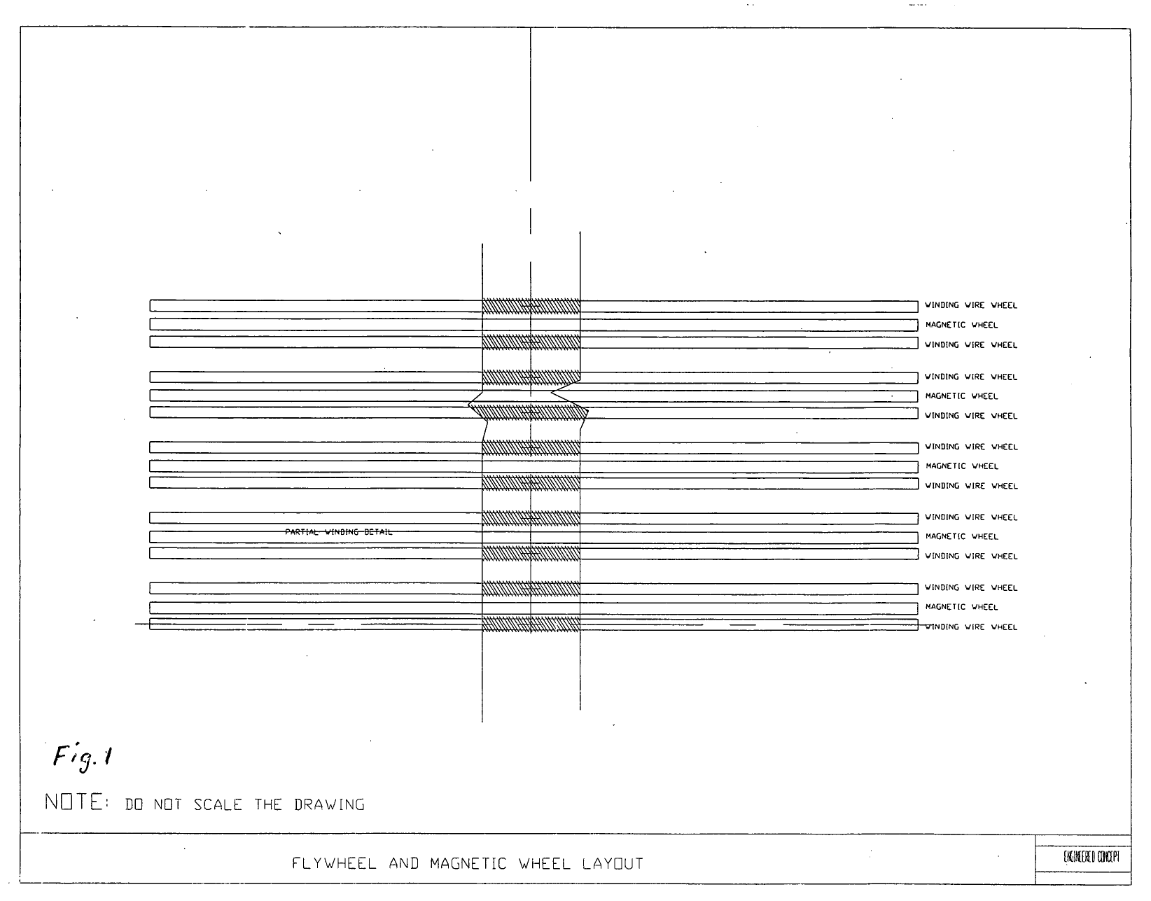

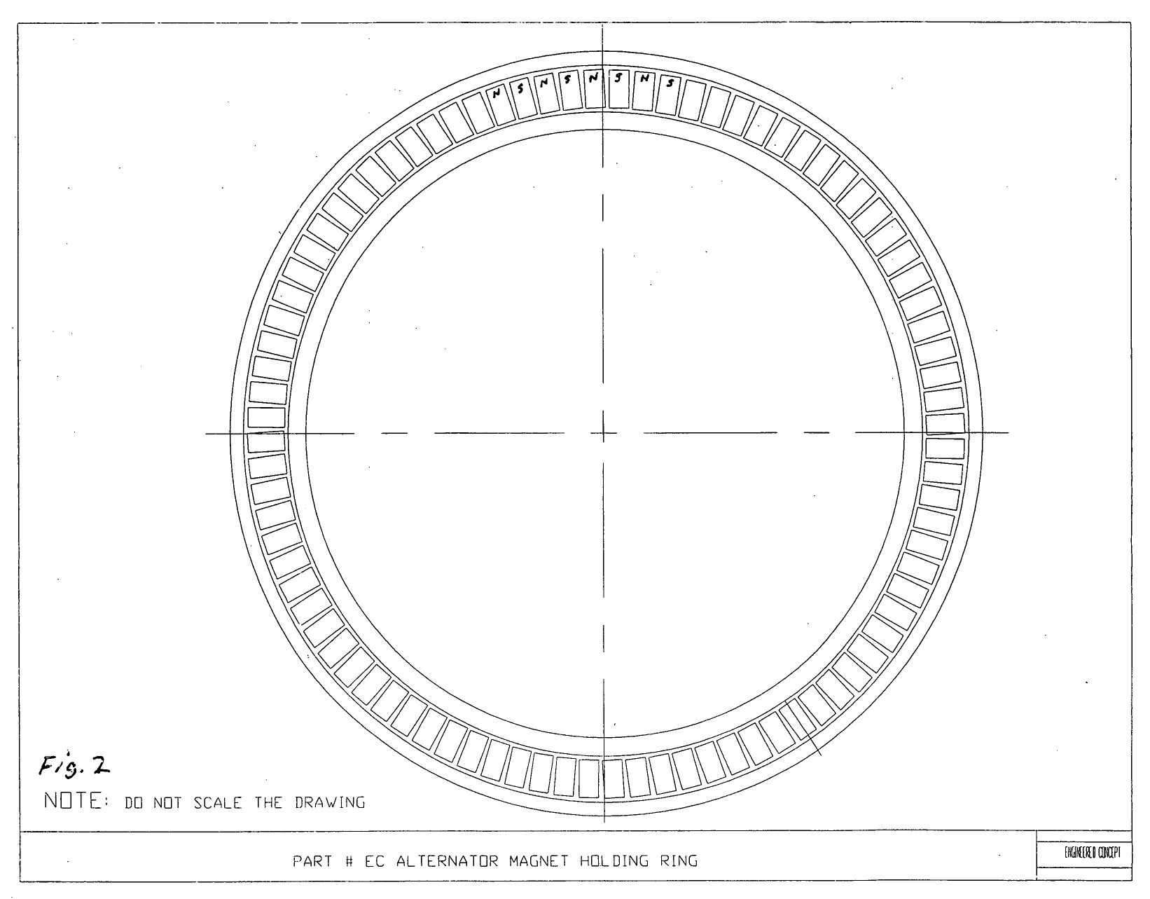

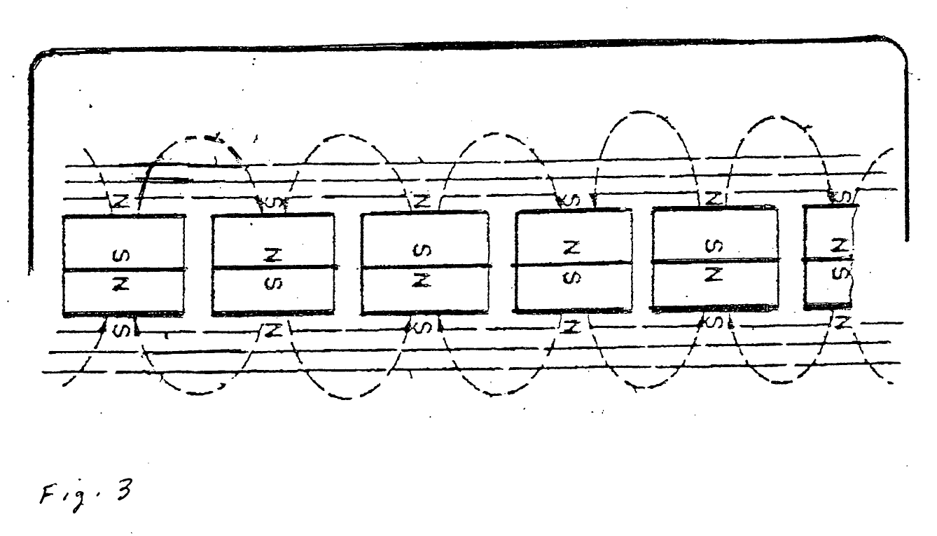

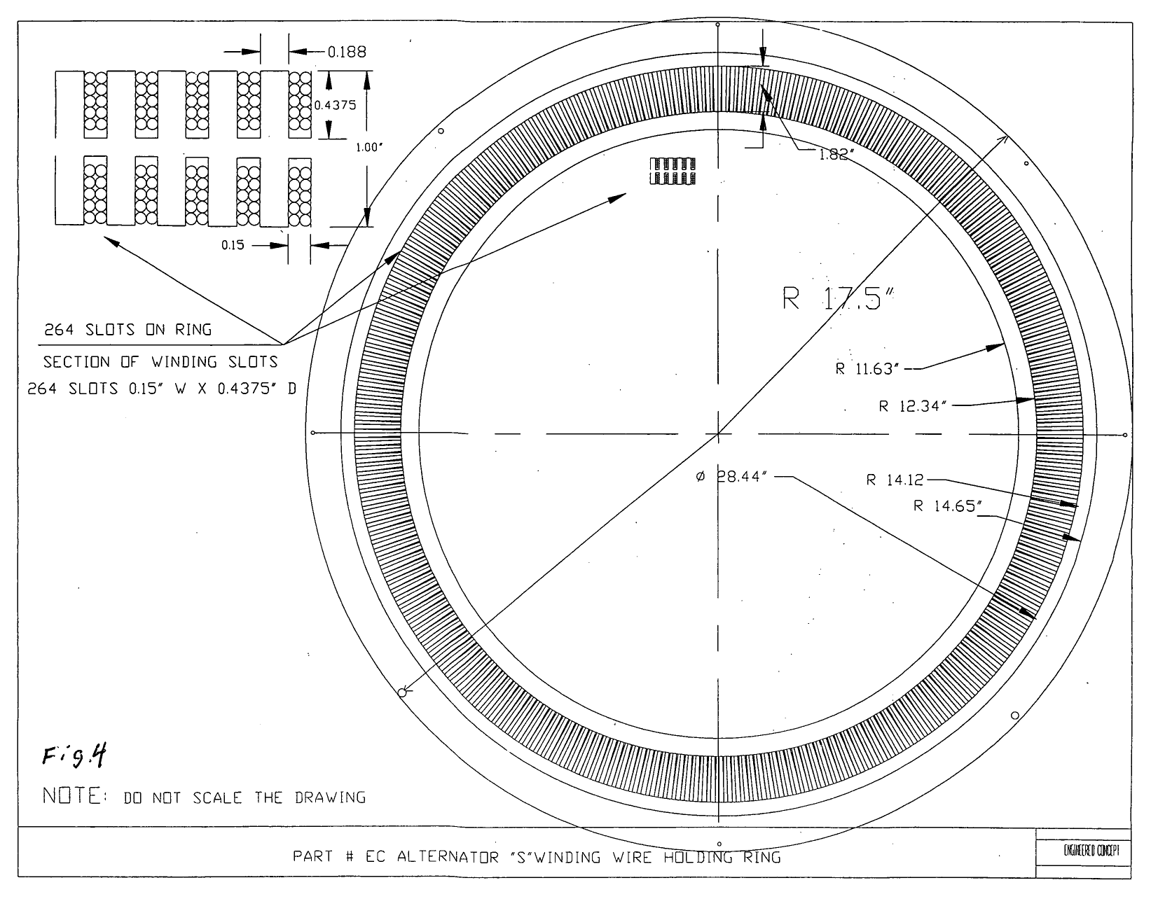

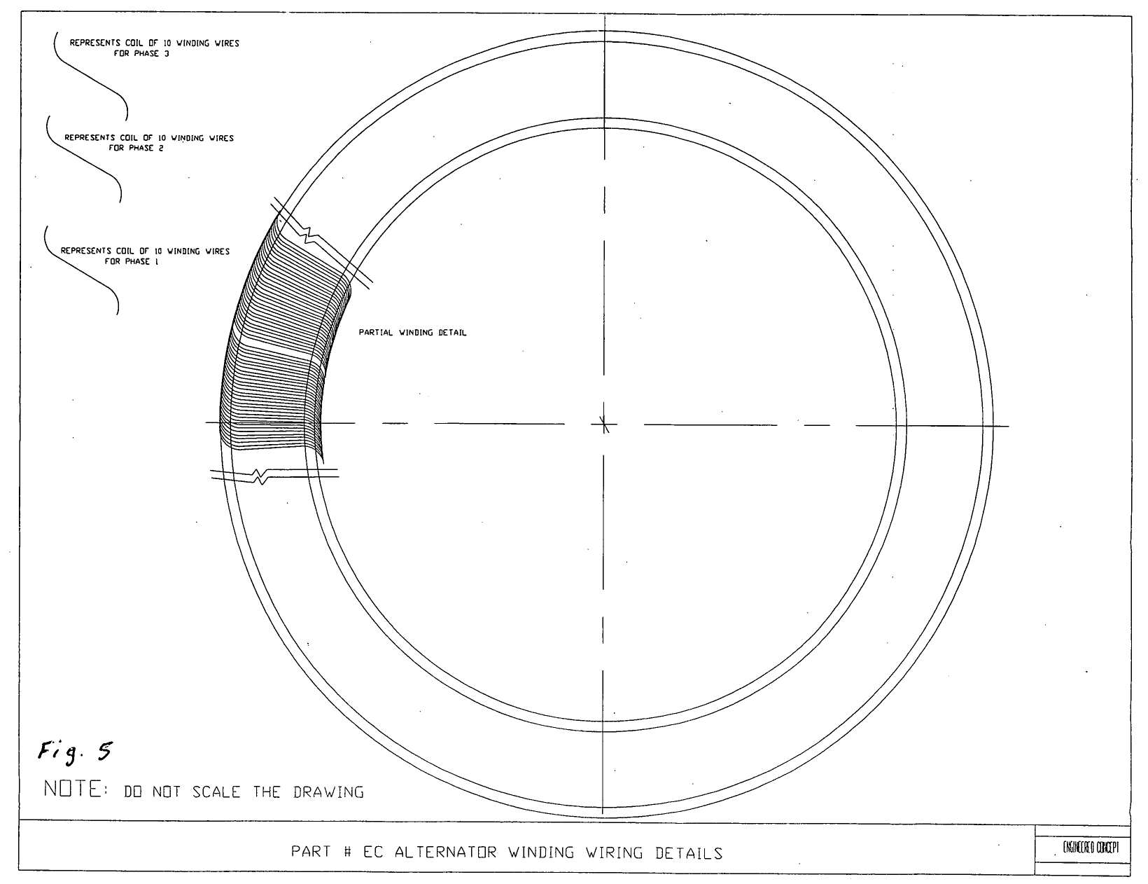

The magnet wire holders are supported at the outer rim between the top and bottom plates with typical fixed supports so that the flywheels or rotors can rotate freely between the magnet wire holders or fields. The windings as seen in FIGS. 4 and 5 are positioned in close proximity to the pancake flywheels or rotors so that as the magnets turn as seen in FIG. 1 E mirror their poles in the copper windings as seen in FIGS. 3, 4 & 5.

As illustrated in FIG. 5 the copper windings are wound in a sinusoidal “S” fashion so that each set of copper magnet wire windings becomes one alternating phase in a balanced three-phase relationship (Phases A, B and C).

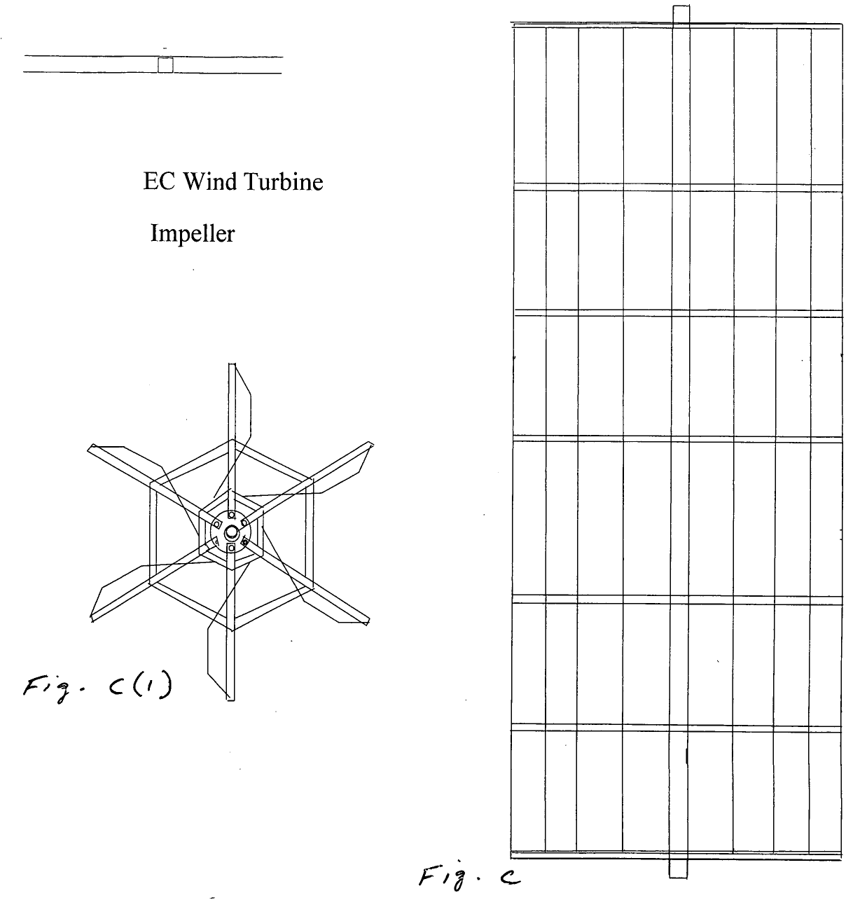

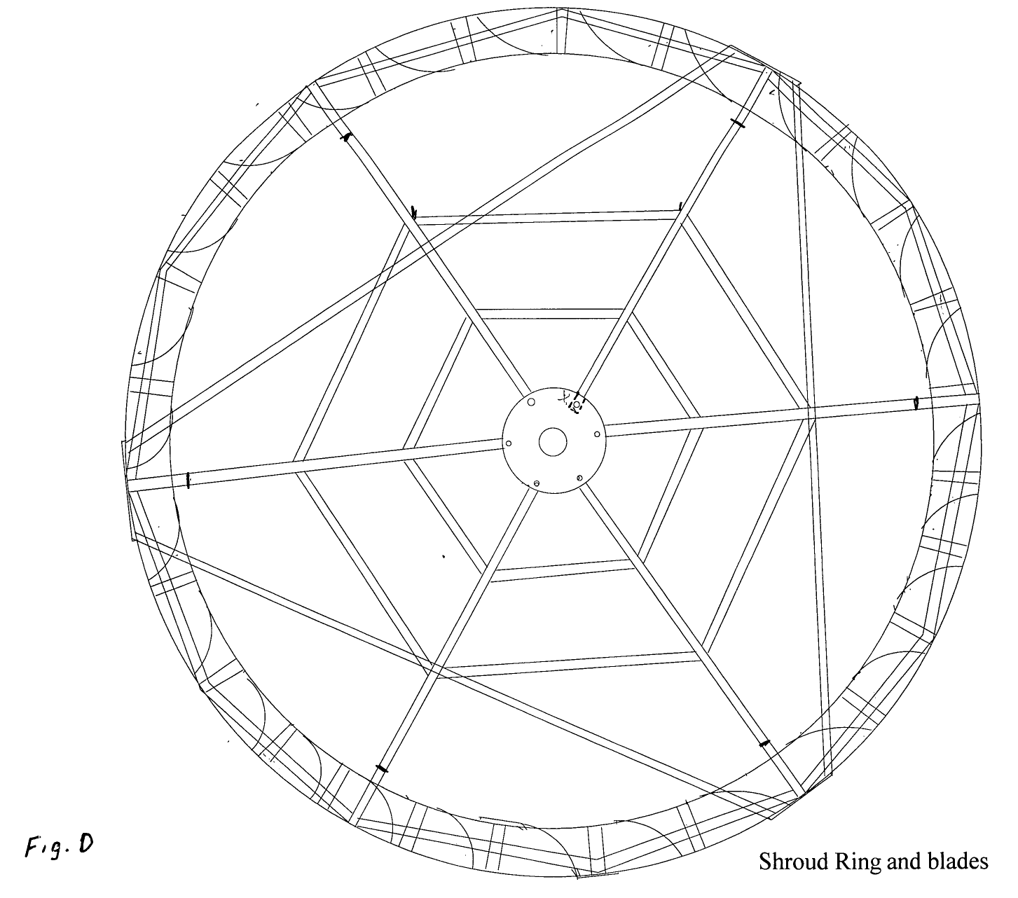

The physical position of each set of windings of the copper magnet wire as seen in FIGS. 4 & 5 places each phase exactly 120 electrical degrees from each other phase in relation to the magnets in the flywheel/rotors as seen in FIG. 2.

The positioning of the copper magnet wires (phases A, B, C) as seen in FIG. 4 stacks them vertically within slots as shown. For example, magnet wire winding A occupies each third slot in the holder. Winding B is positioned identically in the slots next to A, and C in the same manner to B. Thus there is complete symmetry in each winding and each phase around each complete magnet wire holder as seen in FIGS. 4 & 5. The bearing housings adjacent to the electromagnetic field and the magnet wire supports are made of a suitable non-ferrous, non-electrically conductive, non-magnetic material.

Field winding holders in FIGS. 1 & 4 are positioned in relation to each other so that A, B and C are each in their own phase at 120 electrical degrees with each other in each winding holder.

Flywheels or rotors as seen in FIG. 1 are positioned on the shaft in relationship to each other so that each magnet pole is in attraction to the magnet pole on the adjacent flywheel or rotor N to S or vice versa as seen in FIG. 1. The distance between the flywheels or rotors must be such that the gauss or field strength of the magnets is not diminished between them. Typically with Barium Ferrite “domino” magnets placed N to S in the flywheel as seen in FIG. E that dimension is found to be one and one half inches maximum.

Therefore, the thickness of the magnet wire holder containing the three phases of the copper magnet wire between the flywheels must always be less than one and one half inches when using Barium Ferrite “domino” magnets. This dimension will vary with compatible magnets of different composition and configuration.

The position of the multiple slots in the magnet wire holder as seen in FIGS. 4 & 5 equal three slots for each magnet matching each of the three phases in the field adjacent to each magnet. Since each magnet pole in one flywheel is aligned in attraction to the opposite pole of each magnet in the adjacent flywheel, as the rotors turn, an alternating current is moved along each set of windings resulting in three equal phases 120 electrical degrees apart. The double set of windings between flywheels are separated from the Bloch Wall so that each set reacts to its own series of magnetic fields as seen in FIG. 1.

A thin film of non-magnetic, non-electrically conducting, non-ferrous material is placed between each double set of magnets as seen in FIGS. 2 & 3 in each flywheel. Experiments and tests separating sets of Ceramic VIII “domino” magnets from each other with a thin insulator enhances the depth of the magnetic field in motion. Though the enhanced magnetic effect is minimal in a static state, tests indicate that the depth of the magnetic field is further enhanced when the flywheels are in motion moving past the magnet wire windings as seen in FIG. 1.

Not only is the magnetic field enhanced in this novel alternator design, but the electromagnetic field is influenced by the interaction of the permanent magnets in motion between the phases of the copper magnet wire windings.

When a magnet is set in motion past a copper winding the pole of the magnet exposed to the copper wire mirrors itself in the copper wire. If the action continues the magnetic field around the magnets seeks to move away from the mirrored image in the copper. Like poles repel. When copper windings are placed on both sides of the magnetic field in motion as shown in FIG. 1 in this novel alternator design, the magnetic field seeks to move outward toward the rim or inward toward the hub of each pancake flywheel.

The loops of the sinusoidal “S” windings as seen in FIG. 5 are positioned adjacent to the metallic chemical element with a free electron. One reason for this is so that the magnet wire windings A, B and C will be positioned in a straight line radially inwardly and outwardly adjacent to the poles of the magnets. The resultant effect of the interaction between the magnets and metallic chemical element possessing a free electron in motion past the copper magnet wire windings is that the magnetic field is influenced to move radially outward from the hub and radially inward from the rim so that the magnetic field is influenced back into the area occupied by the copper magnet wire windings A, B and C enhancing the action of the cutting of the magnetic lines at a greater angle. The optimum electrical current is generated with minimal eddy current losses when the copper magnet wires cut the magnetic field at such an angle as to allow the freest movement of paired electrons along the copper magnet wire windings. The design and interaction of this unique generating device enhances and influences the electromagnetic field to produce the optimum voltage and amperage with a minimum of eddy current losses.

Under the above described action the torque required to turn the rotor is significantly reduced, the operating efficiency is increased and the heat rise of the operating electromagnetic field is minimized. There are several theories that have been postulated to explain this phenomenon:
1. The magnetic field in motion along the copper magnet wire windings radiates that field into the outer ring and inner hub of the metallic chemical element possessing a free electron through the loops. This action combines with the free electron to induce the outer ring and inner hub to influence the movement of the magnetic field.
2. Each pole of the magnets in the flywheel in motion induces a pole in the metallic chemical element possessing a free electron. Since like poles repel the magnetic field under normal circumstances would collapse. However, in this novel device the magnetic field is influenced back into the presence of the copper magnet wire windings.
3. At least two scientists/engineers, Sparky Sweet and Dr. Bob Beck theorized that the flywheel or rotor made of a chemical material possessing a free electron using Ceramic VIII magnets and rotating in a field of copper windings produced a “negative north” and “negative south” pole in the chemical material possessing a free electron. These “negative poles” formed an electromagnetic barrier preventing the magnetic field from collapsing or moving away from the presence of the copper magnet wire winding.

No ferrous magnetic materials are used in the construction of the alternator in the electromagnetic field except the ferrite particles in the ceramic VIII magnets. The eddy currents, hysteresis and resultant heat present in conventional alternators are virtually nonexistent in this unique device contributing to its high efficiency.

The component construction of this alternator design is extremely simple. Materials utilized in its construction are readily available, easy to work with and relatively inexpensive.

Each flywheel may be cut from one single plate of material made of one of the metallic chemical elements which possess a free electron forming an outer ring and center hub into which the ring of magnets can be secured. Magnets such as the Ceramic VIII are readily available at a very reasonable cost.

Room temperature, two part epoxy/adhesives for molding the magnets, the aluminum hub and ring into one integral piece are readily available.

The form holding the copper magnet wire windings can be made in multiple sections coupled together using suitable material such as epoxy, fiberglass or other non-conductive, non-ferrous and non-magnetic forming material.

Since the windings are stationary, no slip rings or other complex mechanisms are needed to generate the flow of the current. Since the magnets are permanent, enhanced and influenced by their interaction in the electromagnetic field in motion no mechanism other than the motive power to turn the flywheels is needed to activate the magnetic field.

Inasmuch as the result is a balanced, star (delta), three-phase output the design further enhances the voltage intensive overall efficiency of the device. As more flywheels and windings are added each additional magnetic field further intensifies the adjacent and overall magnetic fields. The combined and integrated electromagnetic fields further accommodate the freer flow of paired electrons.

The combination of the above described materials results in a significantly improved alternator both in component design as well as higher efficiency and voltage intensive output. Though only a ten flywheel arrangement is illustrated and described it is obvious to those who are skilled in electromagnetics that modifications and changes can be made in the device without departing from the spirit of the invention or from the scope of the appended claims.

What is claimed is as follows:

1. A unique vertical shaft, horizontally drive, shrouded wind turbine designed to extract energy from the wind not only in a two dimension cross section, but with unique cubic air energy extraction capable of extracting wind energy in wind speeds as low as 2 mph with no need for complex controls to direct the unit into the wind, adjust the impeller blades or shut down the system in higher wind speeds as the very design of the shroud limits the speed of the impeller. The output shaft of the wind turbine is coupled to:

2. An electrical generating device comprised of multiple flywheels containing pairs of non-electrically conductive, enhanceable and influenceable magnets, axially arranged so that the magnet pairs are in attraction to each other at all times within each flywheel and flywheel to flywheel, retained between a hub and outer ring of a metallic chemical element containing a free electron,
Single (outside) and paired (inside) axially arranged and equally space positioned copper magnet wire holders made of a non-magnetic and non-electrically conductive material adjacent to, but not in physical contact with the flywheel/rotors,
Each of said magnet wire holders contains multiple windings of copper magnet wire in sinusoidal “S” configurations around the peripheral of the holders in three distinct separate circuits forming three phases 120 electrical degrees from each other phase within each magnetic field,
Said flywheels are in the shape of a solid disc forming the hub and an outer ring of predetermined thickness and defining a set dimension for the positioning of a paired ring of permanent magnets around the circumference between the hub and the outer ring,
A plurality of paired non-conductive permanent magnets are mounted in attraction to each other radially around the circumference and through the thickness of the flywheel each magnet separated from adjacent magnets by a thin insulator that is non-magnetic, non-ferrous and non-electrically conductive.
Said magnets arranged in alternately opposite poles in the same flywheel as well as in adjacent flywheels so that as the flywheels rotate the magnets pass the suspended three phases of the sinusoidal “S” windings inducing a field mirror of paired electrons that move along the magnet wire coils.
The predetermined position of the copper magnet wire windings to the sets of magnets is such that the electrons pair with each other therein producing a magnetic field that aids rotation of the rotor, reduces and minimizes eddy currents and resistance to electromagnetic rotation,
The connection of each separate phase winding in series then in a balanced three-phase star winding creates a voltage intensive output even greater in efficiency, thus further reducing eddy currents and heat resistance,
Said sinusoidal “S” windings are arranged so that the radial turns of the coils are positioned adjacent to, but not in contact with the solid disc hub and outer ring of the flywheel made of a metallic chemical element possessing a free electron so that when the flywheels are in motion the electromagnetic interaction between the current flowing along the copper magnet wire and the hub and outer ring influence the magnetic field toward the copper windings rather than allowing it to collapse and move away radially inwardly into the hub and outwardly into the outer ring.
The stated predetermined thickness of the metallic chemical element containing a free electron being sufficient so that pairs of permanent magnets may be inserted with a thin electrically non-conductive, non-ferrous material physically isolating the magnets from each other which enhances the influence of the magnetic field in rotation within the electromagnetic field.
1. The device described and detailed in claim 2 wherein said pairs of permanent magnets preferably of the Ceramic VIII type are placed in attraction to each other having unlike poles facing each other with a thin before described insulator between them.
2. The device set forth in claim 2 wherein multiple flywheels are positioned in relation to each other so that all the poles around the perimeter of each flywheel are exactly opposite unlike poles in adjacent flywheels and at all points around the magnet circumference the same distance from the adjacent flywheels so that the gauss strength of the magnetic field is not diminished between the magnets from one flywheel to the next.
3. The device set forth in claim 2 wherein stationary and fixed sets of magnet copper wire sinusoidal “S” winding are placed in the magnet fields between and adjacent to each of the multiple flywheels so they will mirror in the wire the pole of the magnet adjacent to them when the flywheels are in motion. Said windings are arranged on their supports in such a manner so that the copper wire cuts the magnet lines at such an angle as to allow the freest movement of paired electrons along the copper magnet wire windings on each side of the Bloch Wall.
4. The device set forth in claim 2 wherein the stationary and fixed sets of windings are positioned in three phases exactly 120 electrical degrees from each other set of windings in the same holder so that they respond electromagnetically at the same time in each phase to each set of magnets in each flywheel.
5. The device set forth in claim 2 contains copper magnet wire windings connected with each other throughout the device so that each electrical phase is in a series with its own phase, A to A, B to B, and C to C, resulting in a voltage intensive generating device reducing resistance and eddy current losses.
6. The device set forth in claim 2 wherein no ferrous metal or electrically conductive material other than the material made of one of the metallic chemical elements which possess a free electron, the copper magnet wire or ferrite in the permanent magnets is utilized in the electromagnetic field of the alternator.
7. The device set forth in claim 2 wherein the component design of the flywheels and the windings readily lend themselves to the installation of additional flywheels and windings further increasing the potential output of the generating device.
8. The device set forth in claim 2 demonstrates that with the installation of additional flywheels and copper magnet wire sinusoidal “S” windings the electromagnetic field is enhanced and further influenced by the adjacent magnet field and windings further enhancing the movement of paired electrons and reducing electrical resistance, eddy current and heat losses in the generating device.
